(19) United States
(12) Patent Application Publication
(10) Pub. No.: US 2005/0257808 A1
(43) Pub. Date: Nov. 24, 2005

(54) Floss - dispense cap

(76) Inventor: Sandra Senzon, New York, NY (US)

Correspondence Address: SANDRA SENZON, 200 MADISON AVE., NEW YORK, NY, 10016, US

(21) Appl. No.: 10/716,742

(22) Filed: May 21, 2004

(51) Int. Cl. A61C 15/00

(52) U.S. Cl. 132/324

(57) ABSTRACT

The object of the invention is to produce an easy and convenient means of dispensing the floss, along with adjustable cap for every tube, for fast and natural all-in-one cleaning of the mouth. The object would promote the more general use of both, floss and paste for everyday hygiene.

### BACKGROUND OF THE INVENTION

This invention relates to improvements in floss dispensing devices, and more particularly to a cap for toothpaste containers, serving as a dispenser with special prepared thread or yarn (pH floss and herbal coated yarn known as dental floss) which is used for removal of food particles in between the teeth.

The use of the dental floss dispensers is known in a prior art. The dispensers designs are usual and their configurations are common, the following are found examples:

U.S. Pat. No. 5,076,302 to Chari discloses an apparatus for and method of dispensing dental floss.

U.S. Pat. No. 4,428,389 to Sanchez Cordero discloses a dental floss dispenser adapter to the cap of the common toothpaste.

U.S. Pat. No. Des. 336,782 to Vela et al. Discloses a combined toothbrush, toothpaste dispenser and dental floss holder unit and cover therefor.

U.S. Pat. No. 4,919,156 to Gipson discloses a combination dental device.

U.S. Pat. No. 4,957,125 to Yaneza discloses a toothbrushing assembly.

U.S. Pat. No. 4,827,951 to Grussmark discloses a dental floss and toothpaste container.

The object of the invention is to provide an easy and convenient means of dispensing the floss, along with an adjustable cap for every tube, for fast and natural all-in-one cleaning of the mouth. The object would promote the more general use of the both, floss and paste for every day hygiene.

The primary features of the invention are disclosed in the enclosed drawings, in which

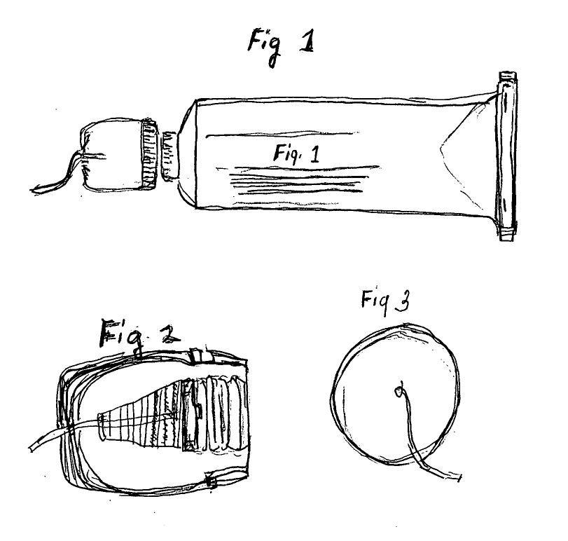

FIG. 1 is a view from a side, of a regular tube of tooth paste with the cap applied;

FIG. 2 is an enlarged, detailed view of the cap in cross section; and

FIG. 3 is the end view of the cap.

The preferable design of the cap would be hallow and round-body shape, of either a metal suitable for the purpose or plastic. The external design/shape may vary to accommodate to any degree of ornamentation desired.

In general, the cap is made up of internally threaded base portion which screws onto the tube of paste. Above the base portion is a hallow receptacle, with the walls converging to an apex and forming a cavity in which a spool of floss is enclosed. At the apex of the receptacle is a small opening through which the free end of the floss is to be withdrawn as much as needed.

The spool should consist of a circular base plate, in which is mounted a spindle with floss compactly wound around, in such way that it'll be easy and simple to draw floss through the opening.

1. Floss in the cap relates to a dispensing devices. And more particularly to a cap for toothpaste and other containers, serving as a dispenser with special thread or yarn. The thread/yarn has herbal coating to whiten and clean between the teeth. The thread and yarn (floss) incorporated with camellia seed oil, which whitens in between teeth while removing food particles from under the gum This special floss will also break the plaque to teeth. This Invention unlike ordinary floss attaches to the tubes, bottles, or other dispensers.
